(19) United States
(12) Patent Application Publication
(10) Pub. No.: US 2026/0093926 A1
(43) Pub. Date: Apr. 2, 2026

(54) DATA PROCESSING METHOD AND DEVICE

(71) Applicant: Lenovo (Beijing) Limited, Beijing (CN)

(72) Inventor: Hai YU, Beijing (CN)

(21) Appl. No.: 19/340,869

(22) Filed: Sep. 26, 2025

(30) Foreign Application Priority Data
Sep. 30, 2024 (CN) 202411389165.2

(51) Int. Cl. G06F 40/30; H04L 67/306

(52) U.S. Cl. CPC G06F 40/30; H04L 67/306

(57) ABSTRACT

A data processing method includes: in response to obtaining multiple data entries from multiple users, identifying a first user intent represented by the multiple data entries; performing generation processing based on the first user intent to obtain a target file, wherein the target file corresponds to a user intent represented by at least one of the multiple data entries.

### CROSS-REFERENCE TO RELATED APPLICATION(S)

This application claims priority to Chinese Patent Application No. 2024113891652 filed on Sep. 30, 2024, which is incorporated herein by reference in its entirety.

### FIELD OF THE TECHNOLOGY

The present disclosure relates to a field of artificial intelligence technology, and in particular to a data processing method and device.

### BACKGROUND

For data generation projects (such as raw images, raw text, raw video, raw audio, or the like) that require collaboration among multiple people, a discrete or serial working method is usually adopted. This method means that participants may not generate the same data at the same time. For example, in the text-to-image scenario, one participant first inputs a text description and generates a preliminary image based on the description. The next participant then iterates and optimizes the image, and so on, until all participants optimize the image of their previous participant. However, because each participant only focuses on their own task, the correlation between them is low, which may make the generated image not meeting the text description or the expectations of some participants, thus affecting the overall effect of the final work.

### SUMMARY

A data processing method includes: in response to obtaining multiple data entries from multiple users, identifying a first user intent represented by the multiple data entries; performing generation processing based on the first user intent to obtain a target file, where the target file corresponds to a user intent represented by at least one of the multiple data entries.

In another aspect, the present disclosure provides an electronic device. The device includes: a memory storing computer program instructions; and a processor coupled to the memory and configured to execute the computer program instructions and perform: in response to obtaining multiple data entries from multiple users, identifying a first user intent represented by the multiple data entries; performing generation processing based on the first user intent to obtain a target file, where the target file corresponds to a user intent represented by at least one of the multiple data entries.

In yet another aspect, the present disclosure provides a non-transitory computer-readable storage medium storing computer program instructions executable by at least one processor to perform: in response to obtaining multiple data entries from multiple users, identifying a first user intent represented by the multiple data entries; performing generation processing based on the first user intent to obtain a target file, wherein the target file corresponds to a user intent represented by at least one of the multiple data entries.

### BRIEF DESCRIPTION OF THE DRAWINGS

Objects, features, and advantages of certain embodiments of the present disclosure become readily apparent by reading the following detailed description with reference to the accompanying drawings. The accompanying drawings illustrate certain embodiments of the present disclosure by way of example and not limitation, where:

In the accompanying drawings, identical or corresponding reference numerals denote identical or corresponding parts.

FIG. 1 is a schematic flow chart of a data processing method provided in certain embodiments of the present disclosure;

FIG. 2 is a schematic flow chart of a keyword method provided in certain embodiments of the present disclosure;

FIG. 3 is a schematic diagram of a structure of a data processing device provided in certain embodiments of the present disclosure; and

FIG. 4 is a schematic diagram of components and structure of an electronic device provided in certain embodiments of the present disclosure.

### DETAILED DESCRIPTION

To make the objectives, features, and advantages of this disclosure more apparent and understandable, the following provides a description of the technical solutions in certain embodiments of this disclosure, in conjunction with the accompanying drawings. The described embodiments represent only a portion of embodiments of this disclosure, and not all of them. Other embodiments derived by persons skilled in the technical field based on certain embodiments of this disclosure without inventive effort are within the scope of protection of this disclosure.

In the following description, references to “certain embodiments” describe a subset of all possible embodiments. However, it should be understood that “certain embodiments” may be the same subset or different subsets of all possible embodiments, and may be combined with each other without conflict.

In the following description, the terms “first” and “second” are used to distinguish similar objects and do not necessarily represent a specific ordering of the objects. Terms “first” and “second” may be interchanged, where, in a specific order or sequential order, so that certain embodiments of this disclosure described herein may be implemented in an order other than that illustrated or described herein.

Unless otherwise defined, technical and scientific terms used in this disclosure have the same meaning as commonly understood by persons skilled in the technical field to which this disclosure relates. The terminology used in this disclosure is for the purpose of describing certain embodiments of this disclosure and is not intended to limit this disclosure.

In the various embodiments of the present disclosure, the size of the serial number of each implementation process does not necessarily mean the order of execution. The execution order of each process should be determined by its function and internal logic, and should not constitute any limitation on the implementation process of certain embodiments of the present disclosure.

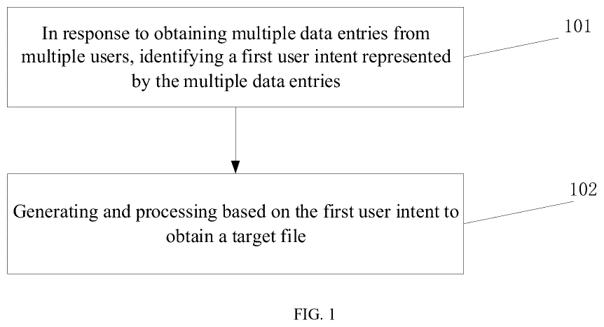

FIG. 1 illustrates a flow chart of a data processing method provided by certain embodiments of the present disclosure. As shown in FIG. 1, the data processing method includes:
101: In response to obtaining multiple data entries from multiple users, identifying a first user intent represented by the multiple data entries;
102: Generating and processing based on the first user intent to obtain a target file, where the target file corresponds to the user intent represented by at least one data entry.

In certain embodiments, the multiple users may be multiple users using the same device, or multiple users of multiple devices, each using a separate device. These users may jointly perform the same task, collaborating to complete the task, such as generating an image, generating text, or generating a video.

The device may be an electronic device such as a computer, a smart terminal, or a tablet computer.

The multiple data entries may include at least one of various types, such as text data, voice data, image data, drawings, operation traces, and gesture traces.

Each data entry may reflect the intent of the corresponding user. By identifying the multiple data entries inputted by multiple users, the first user intent represented by the multiple data entries may be obtained.

The target file may be an image, text, video, audio, a UI (User Interface), computer program code, or the like.

In one example, identifying the first user intent represented by the multiple data entries may involve first identifying each data entry to obtain the user intent of each data entry; then, integrating the user intents of each of the multiple data entries to obtain the first user intent.

In another example, the multiple data entries may be integrated to obtain integrated data entry, and the first user intent may be obtained based on the integrated data entry.

For example, in an image generation task, the first user's data entry may be a text description of the image content (for example, drawing an animal), the second user's data entry may be a text description of the image's artistic style (for example, style of impressionism), and the third user's data entry may be a text description of the image content (for example, drawing a forest with animals). In one example, the user intent of each data entry may be determined, resulting in the first user's user intent being that the image content includes animals, the second user's user intent being that the image is in style of impressionism, and the third user's user intent being that the image content includes a forest with animals. In this manner, after integrating the intents, the first user intent may be: to depict a forest and animals in Impressionism. In another example, the data entry may be integrated to obtain: drawing an animal, drawing a forest with animals, and an image style of impressionism. The first user intention may also be obtained based on the integrated data entry.

In another example, when identifying the first user intent represented by the multiple data entries, the weighting of user intents or the processing strategy may be determined by further considering factors such as user priority (different priorities indicate different importance of different users'data entry), data generation scenarios (such as image generation, text generation, video generation, audio generation, or the like), and usage environment information (such as the environment in which the target file is generated). Other factors that may influence the determination of user intent may also be considered, but these are not limited here.

Accordingly, by identifying the intent of multiple users, misunderstandings and deviations may be reduced, enabling the generation of target files in a collaborative mode, ensuring that the generated target files better meet the expectations of multiple users. By clarifying the first user intent, unnecessary iterations in the generation process may be reduced, thereby improving efficiency.

In certain embodiments, based on the first user intent, a processing model corresponding to the user intent, such as an image generation model, a text generation model, a video generation model, an audio generation model, or a UI generation model, may be used for generation processing. The aforementioned artificial intelligence generated content (AIGC) model may be a local model, a cloud-based model, or a distributed AI model distributed across various terminals to generate and process the target file.

The target file corresponds to the user intent represented by at least one data entry, indicating that the resulting file meets the user intent represented by each data entry, or meets the user intent of one or more of the data entry due to conflicts, user priorities, or a combination of environmental factors, usage scenarios, and so on.

When generating a target file, in addition to considering generation processing on a single device, distributed generation may also be considered, that is, generating the file on multiple devices separately and then performing image, video, audio, or text fusion, or the like.

When generating the target file, the generation processing may also take into account the user profile data of each user, so that the generated data conforms to their respective habits or preferences; and/or the needs of the requester (the requester or recipient of the target file); and/or the generation of corrected or updated data after conflicts between multiple data entries, or the like.

Accordingly, the generated target file better meets the expectations of multiple users and/or requesters, reduces misunderstandings and errors, and improves user and/or requester satisfaction and experience.

In certain embodiments, identifying the first user intent represented by the multiple data entries may include one or more of:

Example 1: Obtaining the second user intent represented by each data entry, performing corresponding processing on the multiple second user intents represented by the multiple data entries to obtain the first user intent, where the first user intent includes at least one of the multiple second user intents, or the intent content of the first user intent corresponds to the intent content of at least one of the multiple second user intents.

In certain embodiments, processing the multiple second user intents represented by the multiple data entries may include: understanding the multiple second user intents represented by the multiple data entries to obtain the second user intent of each user; and integrating the multiple second user intents to obtain the first user intent.

In certain embodiments, integration may be performed by sorting by weights and then filtering, or by weighted integration, based on historical information, or integrating based on associations.

When weighted integration is performed for multiple second user intents, the first user intent may include at least one of the multiple second user intents, and the representation of the first user intent may include one or more of these second user intents. Weighted integration of multiple second user intents may be performed by weighing each second user intent according to its weight, resulting in a balanced result that comprehensively considers the needs of all users.

When integration is performed based on the content of multiple second user intents, the intent content of the first user intent may correspond to the intent content of at least one of the multiple second user intents, and the intent content representing the first user intent may correspond to the intent content of one or more second user intents.

When sorting is performed by weights, each second user intent may be assigned a different weight based on preset criteria (such as user importance, need urgency, or the like), giving priority to intents with higher weights.

When correspondence is performed based on historical information, historical information may include the user's historical behavior data and preferences. This historical data and preferences may help understand user needs and help determine the intent of the current data entry.

Integration based on relationships may analyze the correlations between user data entry to understand how different intents influence or complement each other. These relationships may then be considered during integration to produce more coordinated results.

Accordingly, identifying the secondary user intent represented by multiple data entries using any of the above methods and then synthesizing it to derive the primary user intent allows for a more comprehensive understanding of user needs, improving the accuracy and flexibility of intent recognition.

Example 2: Targeted processing is performed on the multiple data entries to obtain first data entry, and a first user intent represented by the first data entry is identified, where the first data entry includes at least one of the multiple data entries, or the semantic content of the first data entry corresponds to the semantic content of at least one of the multiple data entries.

In certain embodiments, targeted processing may include integrating, sorting, filtering by purpose, or further generative processing of the multiple data entries. Targeted processing may also include converting different types of data entry, such as converting images into text or specific vector data, or converting speech or gestures into text or semantic data.

Processed first data entry is obtained by integrating, sorting, filtering by purpose, or further generative processing of the multiple data entries. The first data entry is then identified based on an intent understanding model or a semantic analysis model to obtain the first user intent.

In certain embodiments, when multiple data entries are integrated, the first data entry includes at least one of the multiple data entries, and the representation of the first data entry may include one or more of these data entries.

When the integration or generation is based on semantic content, the semantic content of the first data entry corresponds to the semantic content of at least one of the multiple data entries, and the representation of the first data entry corresponds to the semantic content of at least one of the data entries.

Accordingly, by performing targeted processing on multiple data entries, it is possible to filter and focus on the user's important intent, thereby improving the accuracy on intent recognition.

Example 3: Obtain target reference information, and identify the first user intent represented by the multiple data entries using a corresponding processing strategy based on the target reference information.

In certain embodiments, the target reference information may include: the data entry type (for example, text data, voice data, image data, drawing, operation trajectory, gesture trajectory, or the like), data generation scenario (for example, image generation scenario, text generation scenario, video generation scenario, audio generation scenario, or the like), user information (for example, user location, priority, permissions, or associations), usage environment information (for example, the environment in which the target file is generated), device configuration information (for example, hardware resource configuration, hardware performance, configuration of various models, or the like), device resource status (for example, device memory usage, load, idle computing resources, network resources, or the like).

In certain embodiments, the first user intent represented by the multiple data entries may be identified using a corresponding processing strategy based on preset rules combined with the target reference information. The preset rules and various processing strategies are set by the developer based on implementation requirements, and the specific content of the preset rules and processing strategies is not limited.

Accordingly, by combining target reference information to select the appropriate processing strategy, the intent recognition process becomes more intelligent and personalized, further optimizing the user experience and providing personalized services to better meet user needs and expectations.

In certain embodiments, processing the multiple second user intents represented by the multiple data entries to obtain the first user intent may include one or more of:

Example 1: Obtaining configuration weights corresponding to the multiple users, and performing weighted integration of the multiple second user intents based on the configuration weights to obtain the first user intent.

In certain embodiments, the first user intent may be a collection of the second user intents represented by the respective data entry.

Configuration weights may be determined based on priority weights, with higher priorities receiving greater weights. Priorities may be determined through negotiation among multiple users or based on other rules, with no set limits. Configuration weights may also be determined based on roles, such as between creators and assistants, teachers and students, or parties A and B, with different weights assigned to different roles.

Different representations of configuration weights reflect the weight given to the second user's intent as represented by the corresponding data entry during integration. In certain embodiments, higher configuration weights give greater weight to the configuration during integration. This weighted integration may be used to resolve both non-conflicting and conflicting choices. For non-conflicting choices, for example, when user A wants to draw a cat on a lawn and user B wants to draw a dog, the generated image might choose either a cat or a dog based on the configuration weights. For conflicting choices, for example, when user A wants to draw two cats on a lawn and user B wants to draw three cats, the generated image might choose two cats (with user A's configuration weight being higher) over three cats based on the configuration weights. For another example, when user A and user C both want to draw a cat, but user B wants to draw a dog, and only one animal may be generated, even when user A and user C's individual configuration weights are lower than user B's, a cat will be generated because the combined weight of user A and user C is greater than user B's.

This weighted integration based on the configuration weights of multiple users more accurately identifies and understands the first user's intent.

Example 2: Obtain configuration weights corresponding to the multiple users, sort the multiple second user intents based on the configuration weights, and select the second user intent in the first sequence as the first user intent, or integrate the second user intent in the first target sequence to obtain the first user intent, where the first target sequence includes at least two sequences.

In certain embodiments, by sorting the multiple second user intents based on the configuration weights, the second user intent in the first sequence may be selected as the first user intent. That is, data generation may be prioritized based on the second user intent with the highest configuration weight, such as prioritizing the intent of the first-ranked user in the main graph. Alternatively, the second user intent in the first target sequence may be integrated to obtain the first user intent, where the first target sequence includes at least two sequences. For example, the second user intents in the second and third sequences may be integrated to obtain the first user intent for data generation; alternatively, the first three or four sequences may be used, and so on.

Accordingly, sorting the second user intents based on the configuration weights prioritizes the most relevant intents, thereby optimizing the data generation process and improving the accuracy and relevance of the results.

Example 3: Obtaining a first association between the multiple second user intents, and integrating the multiple second user intents based on the first association to obtain the first user intent.

In certain embodiments, the first association may represent the degree of similarity or divergence between the second user intent contents, such as semantic similarity.

Accordingly, integrating the multiple second user intents based on the first association to obtain the first user intent may include:

Adjusting the weights of the second user intents based on the degree of similarity or dissimilarity, or deleting or editing the second user intents; and obtaining the first user intent based on the results of the adjustment or deletion. Furthermore, based on the first association, associated intents may be generated between the multiple second user intents, and the multiple second user intents may be integrated to obtain the first user intent.

In this manner, by adjusting or deleting second user intents with lower similarity, the relevance and accuracy of the ultimately identified first user intent may be improved.

Example 4: The multiple second user intents are input into the first generative model for generative processing to obtain the first user intent.

In certain embodiments, the first generative model may be pre-trained and used to combine or assist in expanding user intents. In certain embodiments, the generative capabilities of the first generative model may be directly leveraged to assist in combining or assisting in expanding different second user intents to obtain the first user intent. During implementation, the multiple second user intents are input into the first generative model for generative processing to obtain the output of the first generative model, namely, the first user intent. The first generative model has reasoning and planning capabilities. It extracts key information from the multiple second user intents, combines or assists in expanding the user intents, and fuses them to obtain the first user intent. For example, when user 1 intends to draw an apple and user 2 intends to draw a banana, the first generative model combines or assists in expanding the user intents and generates a plate (for displaying bananas and apples) based on these two intents. The resulting first user intent may be to draw a banana and apples on the plate.

Accordingly, leveraging the capabilities of the first generative model for combination or expansion allows for the flexible integration of multiple second user intents, thereby more comprehensively meeting user needs.

Example 5: Obtain a second association between the multiple second user intents. Input the multiple second user intents and the second associations into a second generative model for generative processing to obtain the first user intent.

In certain embodiments, the second generative model may be pre-trained and used to perform combination or assisting expansion based on the multiple second user intents and the second associations. The second association may represent the similarity or degree of divergence between the second user intents, such as semantic similarity. The second association may also represent the spatial or temporal relationship between user intents, such as generating a cake and generating cookies, and generating a plate for the cake and cookies. The association between a person and water may be swimming in water, drinking water, boating in water, fishing in water, and so on. Generative processing is performed based on the spatial or behavioral logical associations between different intents to supplement the association between the two. During implementation, the multiple second user intents and the second associations are input into the second generative model for generative processing to obtain the output of the second generative model, namely, the first user intent.

Accordingly, the second generation model may flexibly integrate multiple second user intents to more comprehensively meet user needs. Furthermore, by simultaneously considering multiple second user intents and their relationships, more comprehensive information may be captured, thereby improving the accuracy and richness of the generated first user intent.

In certain embodiments, the targeted processing of the multiple data entries to obtain the first data entry may include one or more of:

Example 1: Key data is extracted and grouped from the multiple data entries to obtain at least two different data sets. These different data sets are then combined according to corresponding configuration weights to obtain the first data entry.

In certain embodiments, key data includes keywords or key features. Accordingly, based on the keywords or key features, at least two different data sets may be obtained. These different data sets may be combined according to their corresponding configuration weights. Keywords are then filtered from the grouped data sets according to their weight priority and reorganized to obtain the first data entry. For example, the multiple data entries may include descriptions of different types of paintings. Key data is extracted and grouped to obtain color feature set 1 (for example, red, blue) and theme feature set 2 (for example, spring). These are then combined according to configuration weights (for example, red has a higher weight than blue), resulting in: red as the primary color, with a possible small amount of blue, representing spring.

Accordingly, by extracting and grouping key data, important information may be identified, data organization may be improved, and more accurate first data entry may be generated.

Example 2: The multiple data entries are input into a third generative model for generative processing to obtain the first data entry.

In certain embodiments, the third generative model may be pre-trained. For example, when the data entry is text and the third generative model is a text-generated text model, the multiple data entries are input into the third generative model for generative processing to obtain the first data entry in text form. For example, data entry 1 is a landscape painting depicting autumn leaves against a blue sky; data entry 2 is a tranquil lake reflecting the surrounding mountains and white clouds. Data entry 1 and data entry 2 are input into the third generative model, which is a text-generated text model. The third generative model outputs combined text information based on data entry 1 and data entry 2. For example, the first data entry may be: a fusion of autumn leaves and a tranquil lake, depicting the leaves and mountains against a blue sky.

Accordingly, the third generative model may be used to achieve complex data generation and transformation, enhancing the diversity and depth of data to meet specific needs.

Example 3: Obtain configuration weights corresponding to the multiple users, and perform weighted integration of the multiple data entries based on the configuration weights to obtain the first data entry.

In certain embodiments, the configuration weights may be determined based on priority weights, with the higher the priority, the greater the configuration weight. Priority may be determined by negotiation among multiple users or based on other rules, without limitation. Configuration weights may also be determined based on identity, such as between a creator and an assistant, a teacher and a student, Party A and Party B, or the like, with different configuration weights applied to different identities. For example, the creator, teacher, or Party A has a weight of A, while the assistant, student, or Party B has a weight of B, with A being greater than B, such as A being 60% and B being 40%. When there are multiple assistants or students, the sum of their weights may be B. The weights of each assistant or student may be the same or different, such as Student 1 being 20%, Student B being 10%, and Student C being 10%.

When weighted integration is performed on the multiple data entries based on the configuration weights, different configuration weights give different weights to the data entry during integration. In certain embodiments, the higher the configuration weight, the greater the weight given to the configuration during integration. This weighted integration may resolve both non-conflicting and conflicting choices. For non-conflicting choices, for example, when user A's data entry is to draw a cat on a lawn, and user B's data entry is to draw a dog, then either a cat or a dog may be selected for generation based on the configuration weights. For conflicting choices, for example, when user A's data entry is to draw two cats on a lawn, and user B's data entry is to draw three cats on a lawn, then two cats (with user A's higher configuration weight) may be selected instead of three cats based on the configuration weights. For another example, when users A and C both want to draw a cat, but user B wants to draw a dog, and only one animal may be generated, even when the individual configuration weights of users A and C are lower than those of user B, a cat will be generated because the combined weight of users A and C is greater than that of user B.

Accordingly, by configuring weights to perform weighted processing on the data entry, relevant data may be prioritized according to importance, thereby improving the accuracy and authority of the final results.

Example 4: Obtaining task information for a target task, and based on the task information, selecting at least one second data entry from the multiple data entries, performing conversion processing and/or weighted integration to obtain the first data entry.

In certain embodiments, the target task refers to the task currently received by the device, such as generating an image, generating meeting notes, generating a video, generating audio, and so on. The task information primarily includes the task type, such as generating images, generating text, generating videos, generating audio, and so on. Key second data entry is selected from the multiple data entries as the first data entry to generate the target file.

When the second data entry is unique, conversion processing is performed, including image-to-text conversion or text-to-quantity conversion. When there are multiple second data entries, further weighted integration may be performed to obtain a more complete first data entry.

For example, the task of generating meeting notes involves multiple data sets: data entry 1, which contains some meeting requirements; and data entry 2, which contains a PowerPoint presentation about the meeting. When generating meeting notes, text recognition may be performed on the PowerPoint presentation to obtain the text content. The text content derived from the PowerPoint presentation may then be integrated with the meeting notes from data entry 1. This integration may further consider weights, for example, by highlighting high-weighted content as key points or the main theme of the meeting.

This approach, incorporating task information into processing, ensures data relevance, improves processing efficiency, and enhances the relevance of the results.

Example 5: Obtaining a response result to the multiple data entries and guidance information for the response result, generating the first data entry based on first feedback information regarding the guidance information, and using the guidance information to update attribute parameters of the response result.

In certain embodiments, the response result may be a generated image, audio, text, video, or UI prototype, among others.

The guidance information may be a guidance prompt for optimizing the response result, such as a guidance prompt for prompt input, or optimization or design suggestions for the generated UI.

Feedback information may be a user selection or input other than the options in the guidance information. For example, when the user selects an option recommended by the guidance, the selected option is used as feedback information; when the user rejects the recommended option, the rejection data entry is used as feedback information; or when the user re-enters a new prompt, the newly entered prompt is used as feedback information. For example, in the case of UI design feedback, the guidance information may be to use a minimalist layout for the UI interface, and the feedback information may be to select the minimalist layout. Alternatively, the guidance information may be to use the green color for the UI login button, and the feedback information may be to change the green color to red to match the brand tone.

In UI generation scenarios, user or group feedback on relevant UI design suggestions, or feedback from testing, may also be considered. Further consideration may be given to incorporating user profile information (including individual or group user profiles), or the perceived current usage scenario environment, to generate the first data entry.

In certain embodiments, attribute parameters of the response result may be updated based on the guidance information, primarily to optimize image display or UI display and interaction effects, text display, video parameters, or audio parameters.

Different types of response results correspond to different configuration parameters, such as image parameters for images, audio parameters for audio, string parameters for text, video parameters for videos, and UI display parameters and interaction logic for UIs.

For example, taking UI design feedback as an example, when the color is red, color parameters may be adjusted based on user feedback. Layout parameters, element size, font, and other parameters may also be adjusted. Taking video design feedback as an example, user feedback or user profile information may be used to determine requirements such as video length, frame rate, and background music, and optimize the video accordingly. Taking audio design feedback as an example, user feedback or user profile information may be used to determine requirements such as audio length, number of audio channels (mono, stereo, or dual-channel), and musical style, and optimize the audio accordingly. Taking text feedback as an example, user feedback or user profile information may be used to determine requirements such as font size, paragraph format, and optimize the text accordingly.

Accordingly, data generated based on response results and guidance information may be dynamically updated and optimized, ensuring that the generated data better meets requirements and user input.

Example 6: Processing the multiple data entries into third data entry, and generating the first data entry based on the obtained adjustment operations on the third data entry.

In certain embodiments, processing the multiple data entries into third data entry and generating the first data entry based on the obtained adjustment operations on the third data entry may include: first performing weighted integration on the multiple data entries to obtain the third data entry; then updating the weighted integration result (for example, the third data entry) based on the adjustment operations performed by each user or a specific user (which may be determined based on priority) to obtain the first data entry.

For example, data entry 1 provides an image of a river, and data entry 2 provides an image of a forest. The two images are integrated by weight, for example, the river image may be assigned a 70% weight and the forest image a 30% weight. Assume that multiple users wish to adjust the integration result (the third data entry), and user A (for example, the user with the highest priority) is selected to perform the adjustment. For example, user A wishes to enhance the color of the river and slightly reduce the details of the forest. The final first data entry may then be an image in which the river colors are more vivid and the forest area is relatively subdued.

Accordingly, by processing the third data entry and generating data based on the adjusted feedback, more flexible data output that better meets actual needs may be achieved, thereby improving overall effectiveness.

In certain embodiments, identifying the first user intent represented by the multiple data entries based on the target reference information and using a corresponding processing strategy may include one or more of:

Example 1: Type information of the plurality of data entry is obtained, and a configuration weight for each user is determined based on the type information and user information of the plurality of users. Based on the configuration weight, the plurality of data entry or the second user intents represented by them are weighted and integrated to obtain the first user intent.

In certain embodiments, the first user intent may be a collection of user intents represented by the respective data entry, for example, including at least one user intent.

The type information may include the type of user data entry. In certain embodiments, the weight for each user may be configured based on the degree of alignment between the user information and the type of user data entry and the target task. For example, in a raw image scenario, the configuration weight for inputting stick figures is higher than that for inputting text. In a generated video scenario, the configuration weight for inputting gestures or postures is higher than both stick figures and text. For another example, in a raw image scenario, the configuration weight for a user whose information is a painter is higher than that for a user whose information is a writer. For example, in a raw image task, user A provides a simple sketch (input type: image, in particular an image of a forest with animals). Given their professional background (painter), this input is given a higher weight (70%). User B provides a descriptive text (input type: text, requesting a drawing of a river). Given their background (writer), this input is given a lower weight (30%). By weighted integration of these multiple data entries or their representations of the second user intent, prioritize user A's intent may be prioritized, such as the first user intent of drawing an image of a forest with multiple animals and a river.

Example 2: User profile information for the multiple users is obtained, and a configuration weight for each user is determined based on the user profile information. The multiple data entries or the second user intents represented by them are weighted and integrated based on the configuration weights to obtain the first user intent.

In certain embodiments, the configuration weight for each user is determined based on the user profile information. That is, a weight is assigned to each user based on their user profile information. For example, a weight is assigned based on each user's painting style model. Input from users with a tendency toward realistic style may receive a higher weight for object detail generation.

In certain embodiments, the weighted integration may include combination, fusion, and the like. The weighted integration of the multiple data entries or the second user intents represented by them based on the configuration weights may be performed using a preset model or other means. For example, in a raw image task, user A has a higher weight of 70%, while user B has a lower weight of 30%. User A's second user intent is to draw an image of a forest with animals, while user B's second user intent is to draw an image of a forest with a river. The second user intent is combined or fused to obtain the first user intent: draw an image of a forest with multiple animals and a river. When user A's second user intent is to draw an image of a forest with animals but no river, since user A has a higher weight than user B, the first user intent obtained is to draw an image of a forest with multiple animals but no river.

Example 3: Obtain device information for the target device performing the target task. Based on this device information, identify the first user intent on the first electronic device operated by the target user, or identify corresponding user intents on multiple electronic devices operated by multiple users to obtain the first user intent.

In certain embodiments, the device information may include device configuration information and device usage information, as well as the configuration and usage of the device's hardware resources and the configuration and usage of the device's intent understanding model or large model. In certain embodiments, the device information of the target device performing the target task is used to determine whether to perform intent understanding on the first electronic device or on individual devices. This improves the efficiency of intent understanding by selecting the device to perform intent understanding based on the specific device status.

For example, when performing intent understanding on the first electronic device, such as a tablet, device information includes the operating system, applications, and available hardware resources. When hardware resources are currently limited and the tablet is concurrently running multiple other applications, indicating that the tablet's processing efficiency may be low, intent understanding may be performed on the individual devices. Conversely, when computing resources are sufficient, intent understanding may be performed on the tablet. In certain embodiments, the choice of device to perform intent understanding depends on the specific task requirements and the device's hardware capabilities. Simple tasks may be performed on a tablet, while complex or computationally intensive operations may be handled independently by each device. This may also be combined with the capabilities of each device. For example, when some devices lack an intent understanding model, for example, lack the intent understanding capability, then processing may be delegated to other devices with corresponding capabilities.

In certain embodiments, obtaining multiple data entries from multiple users includes one or more of:
Obtaining multiple data entries from multiple users on the same electronic device for the same target task;
Obtaining multiple data entries from multiple users on different electronic devices for the same target task;
and/or
Identifying a first user intent represented by the multiple data entries includes:
Extracting and grouping key data from the multiple data entries to obtain at least two sets of key data in different categories;
Filtering target key data from the combined key data based on the configuration weights corresponding to each user, and identifying the target key data to obtain the first user intent.

In certain embodiments, the multiple data entries may be multiple data entries from multiple users on the same electronic device for the same target task, such as the same image generation task, text generation task, or video generation task.

The electronic device may be a dual-screen device or a large-screen device with multiple input areas, with each user using a different input area to input data entry. Alternatively, the electronic device may be connected to multiple input components, allowing multiple users to input data entry through different input components, such as a keyboard, microphone, or drawing board.

Multiple data entries may also be data entries from multiple users on different electronic devices for the same target task. For example, data input may be performed simultaneously on multiple devices in response to a target task through conference links or similar applications.

Thus, multiple methods are provided for obtaining data entry from multiple users to subsequently identify the first user's intent.

In certain embodiments, key data includes keywords or key features. Based on the keywords or key features, at least two different types of data sets may be obtained.

In certain embodiments, obtaining multiple data entries from multiple users may include: extracting and grouping key data from the multiple data entries to obtain at least two different types of key data sets; then, based on the configuration weights corresponding to each user, selecting target key data from the key data sets, and identifying the target key data to obtain the first user's intent.

For example, keyword 1, keyword 2, and keyword 3 are extracted from the data entries of user 1, user 2, and user 3, respectively. After grouping, key data set 1 (including keyword 1) and key data set 2 (including keywords 2 and 3) are obtained. When key data set 1 contains only one keyword 1, keyword 1 is selected as the target key data. When key data set 2 contains two keywords, a selection may be made from either of them.

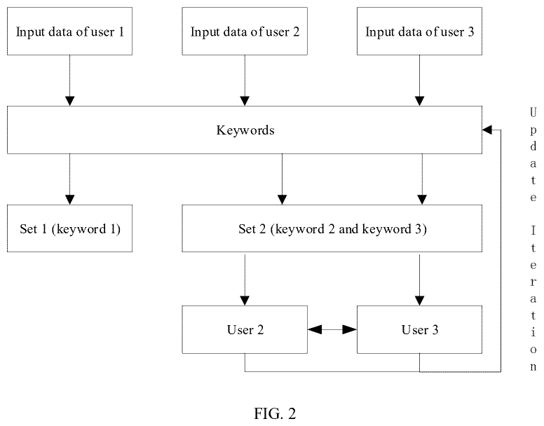

The two keywords may or may not conflict, as shown in FIG. 2. When there is a conflict, selection may be made based on the configuration weights corresponding to each user (the user corresponding to keyword 2 and keyword 3) to obtain the target key data. After selecting a target keyword from keywords 2 and 3, the selected results may be presented to multiple users, who may then decide whether to accept the result. When they disagree, they may continue to enter other keywords to identify target keywords that meet the user's intent. For example, user 1's data entry is: “Draw a comic style forest”; user 2's data entry is: “Draw a forest with animals but no river”; user 3's data entry is: “Draw a forest with a river and animals”; the resulting set 1 describing the style includes: “comic style”; set 2 describing the elements includes: “Forest”, “Animal”, “With a river”, and “Without a river”; When there is a conflict between the “With a river” and “Without a river” options in set 3, a selection is made based on the weights assigned by users 2 and 3. The result is then fed back to users 2 and 3, who may then decide whether to accept the result or make adjustments.

This filtering of key data based on user-configured weights provides more personalized and precise services, optimizes data utilization efficiency, and enhances the user experience.

In certain embodiments, generating a target file based on the first user intent may include one or more of:

Example 1: Generating and processing each user intent within the first user intent separately to generate multiple target sub-files, and then combining or fusing the target sub-files to obtain the target file.

In certain embodiments, the first user intent may be a collection of user intents represented by various data entries, for example, including at least one user intent.

In certain embodiments, generating and processing each user intent separately to generate multiple target sub-files, and then combining or fusing the multiple target sub-files to obtain the target file. For example, each object in an image, each paragraph in a text, or each image frame in a video may be generated first; then, the objects, paragraphs, or frames may be fused into a single target file.

In certain embodiments, whether to combine or fuse may be determined based on the type and relationship of the sub-files, such as combination for images, fusion for text, and splicing for videos.

Accordingly, by processing each user intent separately to generate multiple target sub-files and then combining or fusing them, different types of data may be more flexibly integrated. Selecting a splicing or fusion method based on the characteristics of the sub-files ensures that the final target file better meets user needs, improving content consistency and coherence.

Example 2: Obtaining second feedback on the generation processing result of the first user intent, and updating the generation processing result based on the second feedback information to obtain the target file.

In certain embodiments, an optimization function may be provided for the generation result. For example, the second feedback information may be optimization suggestions for the raw image effect or the generated video. The second feedback information may also be adjustments to image parameters or corresponding positions within the image. The result is optimized based on the second feedback information to obtain the final target file.

For example, the generation processing result obtained based on the first user intent is an image, audio, video, or UI. This is presented to multiple users, who provide feedback on issues such as image style, image element layout, video duration, special effects between video segments, audio channels, audio accompaniment, UI color, and UI layout. Based on the specific feedback, the generation processing result is updated to obtain the target file. Providing optimization functions accordingly may effectively improve the quality of the generation result. Users may make specific improvement suggestions for raw images, audio, video, UI, or the like to achieve a final effect that better meets user expectations. This iterative optimization process not only improves user satisfaction, but also enhances the intelligence level of the system.

Example 3: Based on the third feedback information obtained regarding the first user intent, a third user intent is generated. This third user intent is input into the corresponding fourth generative model to obtain the target file.

In certain embodiments, a function is provided to update user intent based on user feedback. In certain embodiments, the third feedback information may also reflect the updated user intent. An updated third user intent is generated based on the third feedback information, and the final target file, such as an image, video, or audio file, is generated based on the updated third user intent. The fourth generative model may be a local AI model or a cloud-based model.

For example, the first user intent is to generate a comic-style landscape painting; the third feedback information is to increase the brightness of the image and add elements, such as flowers. Combined with the third user intent, the third user intent is generated to generate a bright landscape painting with flower elements. Alternatively, when the third feedback information is to change the comic style to a watercolor painting, the first user intent is adjusted based on the third feedback information, resulting in a third user intent of generating a watercolor-style landscape painting.

The third feedback information may be one or more pieces of information. This means a single user may provide multiple pieces of feedback, or multiple users may provide one or more pieces of feedback. The first user intent may also be adjusted based on the multiple pieces of third feedback information to obtain the third user intent.

Accordingly, updating user intent through feedback ensures that generated content always aligns with the user's latest needs. Updating intent based on real-time user feedback enhances personalized service capabilities, ensuring that the resulting text, image, or video better meets user expectations.

In certain embodiments, generating a target file based on the first user intent may include one or more of:

Example 1: Obtaining device information of a target device, and based on this device information, executing the generation operation on a first electronic device operated by a target user, or on multiple electronic devices operated by multiple users, to obtain the target file.

In certain embodiments, considering that device status affects the effectiveness and efficiency of generating the target file, device information may be obtained. This device information may reflect the device's idle state (for example, idle computing resources, idle memory resources, or the like). Based on this device's idle state, a decision is made as to whether to execute the image generation operation on the first electronic device or to perform the collaborative generation operation on multiple devices. For example, when the idle computing resources and idle memory resources of the first electronic device meet the computing and memory resource requirements for generating the target file, the generation operation may be executed on the first electronic device. However, when the idle computing resources and idle memory resources of the first electronic device do not meet the computing and memory resource requirements, the collaborative generation operation may be performed on multiple devices with generation capabilities.

Accordingly, the target file generation operation is rationally scheduled based on the device's idle state, ensuring the effectiveness of generating the target file while avoiding issues caused by resource competition and improving efficiency.

Example 2: Obtaining the target requestor's requirement information, generating and processing the target file based on the requirement information and the first user intent, where the target demander is the recipient of the target file.

In certain embodiments, the requirement information of the requestor may be obtained, and the target file may be generated based on the requirement information. In certain embodiments, the requestor is the requestor or recipient of the target file. The requirement information may include requirements for image style, video format, video parameters, text themes, and so on.

In certain embodiments, specific requirement information may be obtained from the requestor in advance, such as the required format, style, and content. This requirement information may be analyzed and used as data entry, with the requestor's requirement information given the highest weight. A fourth user intent is derived from the first user intent, and generation processing is performed based on the fourth user intent to obtain the target file. Alternatively, a determination may be made as to whether the first user intent conflicts with the requirement information. When there is no conflict, the first user intent is retained. When there is conflict, the first user intent is adjusted, and generation processing is performed based on the adjusted first user intent to obtain the target file.

Accordingly, generating the target file based on the requestor's requirement information may accurately meet the requestor's specific requirements for images, videos, text, and so on, improving the relevance and applicability of the target file.

Example 3: Obtain user profile information for the multiple users, and update the generated results for the first user intent based on the user profile information to obtain the target file.

In certain embodiments, user profile information may reflect the habits or preferences of different users. After generating the generated results for the first user intent, the generated results may be adjusted based on the habits or preferences of different users to obtain a target file that meets the user preferences. For example, after generating an image, the image may be further processed based on the habits or preferences of different users to obtain an image that meets the user's habits.

In certain embodiments, after obtaining the generated results, the generated results for the first user intent may be updated based on the user profile information of the multiple users to obtain the target file. For example, when the generated result is an image, and based on the user profile information of the multiple users, it is determined that a large number of users (or users with high weight) like warm colors (such as orange, yellow, or pink), after generating the image, the image hue is detected to determine whether it is a warm color or whether it includes the color in the user profile information. If not, the image hue may be adjusted to a warm color. For example, the generated result is a video that contains the basic elements of a beach sunset, such as the beach, the sea, and the setting sun. Based on user preference information, it is determined that a significant number of users (or users with a high weight) have specific preferences when watching beach sunset videos, such as clearer and more transparent water and background music with gentle waves mixed with seagulls. Based on the user profile information, the video may be updated using a color correction algorithm to enhance the clarity of the water and replace the background music with gentle waves mixed with sound of seagulls, ultimately generating the target file.

In certain embodiments, after obtaining the generated result, the generated result for the first user intent may also be updated based on each user's user profile information to obtain the target file corresponding to each user. For example, when the generated result is a travel video, and user A likes rock music and user B likes country music, the background music of the travel video may be modified to rock music for user A and to rock and country music for user B.

Accordingly, by updating the generated result based on user profile information, personalized, accurate, and dynamically adapted content may be provided.

In certain embodiments, the method further includes one or more of:

When the target file is an image file, displaying identification information of a target image object on the image, the identification information including identification information of a target user;

When the user information of multiple users changes, updating the output parameters of the target file.

When the image file includes multiple image objects, such as a cat, a tree, or an object, identification information may be added to each target image object. This identification information may include the name or title of the creator of each image object.

The target user is the provider of the data entry required to generate the target image object. The identification information of one user or all users may be displayed, and may also be displayed as a watermark based on the user's choice or preference.

When a user leaves or changes, image output parameters and display parameters may be updated, such as display style, regeneration of a new image, and so on.

Accordingly, identification information enables users to quickly identify relevant content, improving the personalization and targeting of images. Furthermore, identification information may be used to better manage and track user preferences and behaviors, providing data support for subsequent optimization. Furthermore, timely updating output parameters based on changes in user information ensures that generated content always meets the latest needs, improving content relevance.

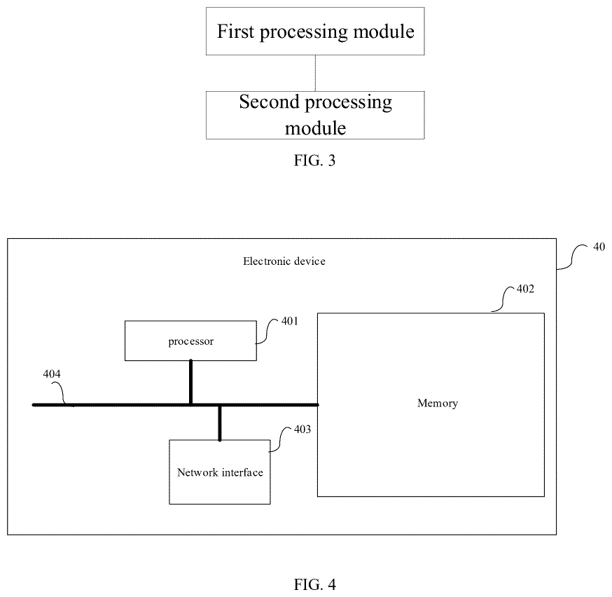

FIG. 3 shows a schematic diagram of the structure of a data processing device provided by certain embodiments of the present disclosure. As shown in FIG. 3, the data processing device includes:
A first processing module, configured to, in response to receiving multiple data entries from multiple users, identify a first user intent represented by the multiple data entries;
A second processing module, configured to generate a target file based on the first user intent, where the target file corresponds to the user intent represented by at least one data entry.

In certain embodiments, the first processing module is configured to perform one or more of:
Obtaining a second user intent represented by each data entry item, performing corresponding processing on the multiple second user intents represented by the multiple data entries items to obtain the first user intent, where the first user intent includes at least one of the multiple second user intents, or the intent content of the first user intent corresponds to the intent content of at least one of the multiple second user intents;
Performing target processing on the multiple data entries items to obtain first data entry, and identifying the first user intent represented by the first data entry, where the first data entry includes at least one of the multiple data entries, or the semantic content of the first data entry corresponds to the semantic content of at least one of the multiple data entries;
Obtaining target reference information, and identifying the first user intent represented by the multiple data entries using a corresponding processing strategy based on the target reference information.

In certain embodiments, the first processing module is configured to perform one or more of:
Obtaining configuration weights corresponding to the multiple users, and performing weighted integration of the multiple second user intentions based on the configuration weights to obtain the first user intention;
Obtaining configuration weights corresponding to the multiple users, and sorting the multiple second user intentions based on the configuration weights, taking the second user intentions in a first sequence as the first user intention, or integrating the second user intentions in a first target sequence to obtain the first user intention, where the first target sequence includes at least two sequences;
Obtaining first association between the multiple second user intentions, and integrating the multiple second user intentions based on the first association to obtain the first user intention;
Inputting the multiple second user intentions into a first generation model for generation processing to obtain the first user intention;
Obtaining a second association between the multiple second user intentions, and inputting the multiple second user intentions and the second association into a second generation model for generation processing to obtain the first user intention.

In certain embodiments, the first processing module is configured to perform one or more of:
Extracting key data and grouping the multiple data entries to obtain at least two different-category data sets, and combining the different-category data sets according to corresponding configuration weights to obtain the first data entry;
Inputting the multiple data entries into a third generation model for generation processing to obtain the first data entry;
Obtaining configuration weights corresponding to the multiple users, and performing weighted integration of the multiple data entries based on the configuration weights to obtain the first data entry;
Obtaining task information for a target task, and based on the task information, selecting at least one second data entry from the multiple data entries for conversion processing and/or weighted integration to obtain the first data entry;
Obtaining response results of the multiple data entries and guidance information for the response results, and generating the first data entry based on first feedback information of the guidance information, where the guidance information is used to update attribute parameters of the response results;
Processing the multiple data entries into third data entry, and generating the first data entry based on the obtained adjustment operations for the third data entry.

In certain embodiments, the first processing module is configured to perform one or more of:
Obtaining type information for the multiple data entries, determining a configuration weight for each user based on the type information and user information for the multiple users, and performing weighted integration of the multiple data entries or the second user intents represented by them based on the configuration weights to obtain the first user intent;
Obtaining user profile information for the multiple users, determining a configuration weight for each user based on the user profile information, and performing weighted integration of the multiple data entries or the second user intents represented by them based on the configuration weights to obtain the first user intent;
Obtaining device information for a target device that performs a target task, and identifying the first user intent on a first electronic device operated by the target user based on the device information, or identifying corresponding user intents on multiple electronic devices operated by the multiple users to obtain the first user intent.

In certain embodiments, the first processing module is configured to perform one or more of:
Obtaining multiple data entries from multiple users on the same electronic device for the same target task;
Obtaining multiple data entries from multiple users on different electronic devices for the same target task;
And/or
Identifying a first user intent represented by the multiple data entries includes:
Extracting and grouping key data from the multiple data entries to obtain at least two sets of key data in different categories;
Filtering target key data from the combination of the key data based on the configuration weights corresponding to each user, and identifying the target key data to obtain the first user intent.

In certain embodiments, the second processing module is configured to perform one or more of:
Generating each user intent in the first user intent to obtain multiple target sub-files, and combine or fuse the target sub-files to obtain the target file.

Obtaining second feedback information on the generation result of the first user intent, and updating the generation result based on the second feedback information to obtain the target file.

Generating a third user intent based on the third feedback information obtained on the first user intent, and inputting the third user intent into a corresponding fourth generation model to obtain the target file.

In certain embodiments, the second processing module is configured to perform one or more of:
Obtaining device information of a target device, and based on the device information, performing the generation operation on a first electronic device operated by a target user, or on multiple electronic devices operated by multiple users, to obtain the target file.

Obtaining request information of a target requestor, and performing generation processing based on the request information and the first user intent to obtain the target file, where the target requestor is the recipient of the target file.

Obtaining user profile information of the multiple users, and updating the generation result of the first user intent based on the user profile information to obtain the target file.

In certain embodiments, the second processing module may also be configured to perform one or more of:
When the target file is an image file, identification information of the target image object is displayed on the image, the identification information including identification information of the target user.

When the user information of the multiple users changes, the output parameters of the target file are updated.

It is understood that when implementing the corresponding data processing method, the data processing device provided in the above embodiments may, as needed, distribute the above processing to different program modules to complete all or part of the processing described above. Furthermore, the device provided in the above embodiments and the corresponding method embodiments are based on the same concept. The specific implementation process is detailed in the method embodiment and will not be repeated here.

The present disclosure in certain embodiments provides a computer-readable storage medium storing executable instructions. The executable instructions stored therein, when executed by a processor, trigger the processor to execute the data processing method provided in the present embodiment.

In certain embodiments, the computer-readable storage medium may be a ferroelectric random access memory (FRAM), read-only memory (ROM), programmable read-only memory (PROM), erasable programmable read-only memory (EPROM), electrically erasable programmable read-only memory (EEPROM), flash memory, magnetic surface mount memory, optical disk, or CD-ROM, among other memories; or may be various devices including any one or any combination of the above memories.

In certain embodiments, the executable instructions may take the form of a program, software, software module, script, or code, written in any programming language (including compiled or interpreted languages, or declarative or procedural languages), and may be deployed in any form, including as a standalone program or as a module, module, subroutine, or other unit suitable for use in a computing environment.

By way of example, executable instructions may be deployed for execution on a single computing device, on multiple computing devices located at a single location, or on multiple computing devices distributed across multiple locations and interconnected via a communication network.

Certain embodiments of the present disclosure provide a computer program product including a computer program/instructions. When executed by a processor, the computer program/instructions implement the data processing method described herein.

FIG. 4 shows a schematic diagram of the structure of an electronic device provided by certain embodiments of the present disclosure. As shown in FIG. 4, the electronic device 40 includes a processor 401 and a memory 402 for storing a computer program executable on the processor. When the processor 401 executes the computer program, it executes the data processing method provided by certain embodiments of the present disclosure.

The electronic device 40 may also include at least one network interface 403. The various components of the electronic device 40 are coupled together via a bus system 404. It is understood that the bus system 404 is used to enable connectivity and communication between these components. In addition to a data bus, the bus system 404 also includes a power bus, a control bus, and a status signal bus. However, for clarity, various buses are labeled as bus system 404 in FIG. 4. There may be at least one processor 401. Network interface 403 is used for wired or wireless communication between electronic device 40 and other devices.

Memory 402 in the disclosed embodiments is used to store various types of data to support the operation of electronic device 40.

The methods disclosed in the disclosed embodiments may be applied to or implemented by processor 401. Processor 401 may be an integrated circuit chip with signal processing capabilities. During implementation, the method may be performed by hardware integrated logic circuits or software instructions in processor 401. Processor 401 may be a general-purpose processor, a digital signal processor (DSP), or other programmable logic device, discrete gate or transistor logic device, discrete hardware components, or the like. Processor 401 may implement or execute the methods, steps, and logic block diagrams disclosed in the disclosed embodiments. A general-purpose processor may be a microprocessor or any conventional processor. The method disclosed in certain embodiments of the present disclosure may be directly implemented by a hardware decoding processor, or by a combination of hardware and software modules within the decoding processor. The software module may be located in a storage medium located in memory 402. Processor 401 reads information from memory 402 and, in conjunction with its hardware, completes the method.

In certain embodiments, the electronic device 40 may be implemented by one or more application-specific integrated circuits (ASICs), DSPs, programmable logic devices (PLDs), complex programmable logic devices (CPLDs), field-programmable gate arrays (FPGAs), general-purpose processors, controllers, microcontrollers (MCUs), microprocessors, or other electronic components to perform the aforementioned method.

Various forms of the flow diagrams shown above may be used, with steps reordered, added, or deleted. For example, the steps described in this disclosure may be performed in parallel, sequentially, or in a different order, as long as the desired results of the technical solutions disclosed herein are achieved. The present disclosure does not place a limitation on this.

In addition, the terms “first” and “second” are used for descriptive purposes only and should not be construed to indicate or imply relative importance or implicitly specify the number of technical features indicated. Therefore, features designated “first” or “second” may explicitly or implicitly include at least one such feature. In the description of this disclosure, “plurality” means two or more, unless otherwise defined.

The above description reflects certain embodiments of the present disclosure, but the scope of protection of the present disclosure is not limited thereto. Any changes or substitutions that may be easily conceived by a person skilled in the technical field disclosed in this disclosure should be included in the scope of protection of the present disclosure. Therefore, the scope of protection of the present disclosure should be based on the scope of protection of the claims.

What is claimed is:

1. A data processing method, comprising:
in response to obtaining multiple data entries from multiple users, identifying a first user intent represented by the multiple data entries; and
performing generation processing based on the first user intent to obtain a target file, wherein the target file corresponds to a user intent represented by at least one of the multiple data entries.

2. The method of claim 1, wherein identifying the first user intent represented by the multiple data entries includes one or more of:
obtaining multiple second user intents respectively represented by the multiple data entries, performing processing on the multiple second user intents represented by the multiple data entries to obtain the first user intent, wherein the first user intent includes at least one of the multiple second user intents, or the first user intent corresponds to at least one of the multiple second user intents;
performing targeted processing on the multiple data entries to obtain first data entry, and identifying the first user intent represented by the first data entry, wherein the first data entry includes at least one of the multiple data entries, or a semantic content of the first data entry corresponds to a semantic content of at least one of the multiple data entries; and
obtaining target reference information, and identifying the first user intent represented by the multiple data entries using a processing strategy based on the target reference information.

3. The method of claim 2, wherein processing the multiple second user intents represented by the plurality of data entries to obtain the first user intent includes one or more of:
obtaining configuration weights corresponding to multiple users, and performing weighted integration of the multiple second user intents based on the configuration weights to obtain the first user intent;
obtaining configuration weights corresponding to the multiple users, and sorting the multiple second user intents based on the configuration weights, taking the second user intent in a first sequence as the first user intent, or integrating the multiple second user intents in a first target sequence to obtain the first user intent, wherein the first target sequence includes at least two sequences;
obtaining a first association between the multiple second user intents, and integrating the multiple second user intents based on the first association to obtain the first user intent;
inputting the multiple second user intents into a first generative model for generative processing to obtain the first user intent; and
obtaining a second association between the multiple second user intents, and inputting the multiple second user intents and the second association into a second generative model for generative processing to obtain the first user intent.

4. The method of claim 2, wherein performing targeted processing on the multiple data entries to obtain the first data entry includes one or more of:
extracting and grouping key data from the multiple data entries to obtain at least two different category data sets, and combining the different category data sets according to corresponding configuration weights to obtain the first data entry;
inputting the multiple data entries into a third generation model for generation processing to obtain the first data entry;
obtaining configuration weights corresponding to the multiple users, and performing weighted integration on the multiple data entries based on the configuration weights to obtain the first data entry;
obtaining task information for a target task, and based on the task information, selecting at least one second data entry from the multiple data entries for transformation processing and/or weighted integration to obtain the first data entry;
obtaining response results from the multiple data entries and guidance information for the response results, and generating the first data entry based on first feedback information on the guidance information, wherein the guidance information is used to update attribute parameters of the response results; and
processing the multiple data entries into third data entry, and generating the first data entry based on adjustment operation for the third data entry.

5. The method of claim 2, wherein identifying the first user intent represented by the multiple data entries using the processing strategy based on the target reference information includes one or more of:
obtaining type information of the multiple data entries, determining a configuration weight for each user based on the type information and user information of the multiple users, and performing weight integration of the multiple data entries or the second user intents represented by them based on the configuration weights to obtain the first user intent;
obtaining user profile information of the multiple users, determining a configuration weight for each user based on the user profile information, and performing weighted integration of the multiple data entries or the second user intents represented by them based on the configuration weights to obtain the first user intent; and
obtaining device information of a target device for performing a target task, and identifying the first user intent on a first electronic device operated by the target user based on the device information, or identifying user intents on multiple electronic devices operated by the multiple users to obtain the first user intent.

6. The method of claim 1, wherein obtaining multiple data entries from multiple users includes one or more of:
obtaining multiple data entries from multiple users on a same electronic device for a same target task;
obtaining multiple data entries from multiple users on different electronic devices for the same target task; and/or
identifying the first user intent represented by the multiple data entries includes:
extracting and grouping key data from the multiple data entries to obtain at least two different category data sets;
selecting target key data from the at least two different category data sets based on configuration weights corresponding to each user, and identifying the target key data to obtain the first user intent.

7. The method of claim 1, wherein generating the target file based on the first user intent includes one or more of:
processing each user intent in the first user intent to obtain multiple target sub-files, and combining or fusing the target sub-files to obtain the target file;
obtaining second feedback information on a generation result of the first user intent, and updating the generation result based on the second feedback information to obtain the target file; and
generating a third user intent based on third feedback information obtained on the first user intent, and inputting the third user intent into a fourth generation model to obtain the target file.

8. The method of claim 1, wherein generating the target file based on the first user intent includes one or more of:
obtaining device information of a target device, and performing the generating operation based on the device information on a first electronic device operated by the target user, or on multiple electronic devices operated by multiple users, to obtain the target file;
obtaining request information of a target requestor, and performing generating operation based on the request information and the first user intent to obtain the target file, wherein the target requestor is a recipient of the target file; and
obtaining user profile information of the multiple users, and updating the generated result of the first user intent based on the user profile information to obtain the target file.

9. The method of claim 1, further comprising one or more of:
when the target file is an image file, displaying identification information of a target image object on an image, the identification information including identification information of a target user; and
when user information of the multiple users changes, updating output parameters of the target file.

10. An electronic device, comprising: a memory storing computer program instructions; and
a processor coupled to the memory and configured to execute the computer program instructions and perform:
in response to obtaining multiple data entries from multiple users, identifying a first user intent represented by the multiple data entries;
performing generation processing based on the first user intent to obtain a target file,
wherein the target file corresponds to a user intent represented by at least one of the multiple data entries.

11. The electronic device of claim 10, wherein identifying the first user intent represented by the multiple data entries includes one or more of:
obtaining multiple second user intents respectively represented by the multiple data entries, performing processing on the multiple second user intents represented by the multiple data entries to obtain the first user intent, wherein the first user intent includes at least one of the multiple second user intents, or the first user intent corresponds to at least one of the multiple second user intents;
performing targeted processing on the multiple data entries to obtain first data entry, and identifying the first user intent represented by the first data entry, wherein the first data entry includes at least one of the multiple data entries, or a semantic content of the first data entry corresponds to a semantic content of at least one of the multiple data entries; and
obtaining target reference information, and identifying the first user intent represented by the multiple data entries using a processing strategy based on the target reference information.

12. The electronic device of claim 11, wherein processing the multiple second user intents represented by the plurality of data entries to obtain the first user intent includes one or more of:
obtaining configuration weights corresponding to multiple users, and performing weighted integration of the multiple second user intents based on the configuration weights to obtain the first user intent;
obtaining configuration weights corresponding to the multiple users, and sorting the multiple second user intents based on the configuration weights, taking the second user intent in a first sequence as the first user intent, or integrating the multiple second user intents in a first target sequence to obtain the first user intent, wherein the first target sequence includes at least two sequences;
obtaining a first association between the multiple second user intents, and integrating the multiple second user intents based on the first association to obtain the first user intent;
inputting the multiple second user intents into a first generative model for generative processing to obtain the first user intent; and
obtaining a second association between the multiple second user intents, and inputting the multiple second user intents and the second association into a second generative model for generative processing to obtain the first user intent.

13. The electronic device of claim 11, wherein performing targeted processing on the multiple data entries to obtain the first data entry includes one or more of:
extracting and grouping key data from the multiple data entries to obtain at least two different category data sets, and combining the different category data sets according to corresponding configuration weights to obtain the first data entry;
inputting the multiple data entries into a third generation model for generation processing to obtain the first data entry;
obtaining configuration weights corresponding to the multiple users, and performing weighted integration on the multiple data entries based on the configuration weights to obtain the first data entry;
obtaining task information for a target task, and based on the task information, selecting at least one second data entry from the multiple data entries for transformation processing and/or weighted integration to obtain the first data entry;
obtaining response results from the multiple data entries and guidance information for the response results, and generating the first data entry based on first feedback information on the guidance information, wherein the guidance information is used to update attribute parameters of the response results; and
processing the multiple data entries into third data entry, and generating the first data entry based on adjustment operation for the third data entry.

14. The electronic device of claim 11, wherein identifying the first user intent represented by the multiple data entries using the processing strategy based on the target reference information includes one or more of:
obtaining type information of the multiple data entries, determining a configuration weight for each user based on the type information and user information of the multiple users, and performing weight integration of the multiple data entries or the second user intents represented by them based on the configuration weights to obtain the first user intent;
obtaining user profile information of the multiple users, determining a configuration weight for each user based on the user profile information, and performing weighted integration of the multiple data entries or the second user intents represented by them based on the configuration weights to obtain the first user intent; and
obtaining device information of a target device for performing a target task, and identifying the first user intent on a first electronic device operated by the target user based on the device information, or identifying user intents on multiple electronic devices operated by the multiple users to obtain the first user intent.

15. The electronic device of claim 10, wherein obtaining multiple data entries from multiple users includes one or more of:
obtaining multiple data entries from multiple users on a same electronic device for a same target task;
obtaining multiple data entries from multiple users on different electronic devices for the same target task;
and/or
identifying the first user intent represented by the multiple data entries includes:
extracting and grouping key data from the multiple data entries to obtain at least two different category data sets;
selecting target key data from the at least two different category data sets based on configuration weights corresponding to each user, and identifying the target key data to obtain the first user intent.

16. The electronic device of claim 10, wherein generating the target file based on the first user intent includes one or more of:
processing each user intent in the first user intent to obtain multiple target sub-files, and combining or fusing the target sub-files to obtain the target file;
obtaining second feedback information on a generation result of the first user intent, and updating the generation result based on the second feedback information to obtain the target file; and
generating a third user intent based on third feedback information obtained on the first user intent, and inputting the third user intent into a fourth generation model to obtain the target file.

17. The electronic device of claim 10, wherein generating the target file based on the first user intent includes one or more of:
obtaining device information of a target device, and performing the generating operation based on the device information on a first electronic device operated by the target user, or on multiple electronic devices operated by multiple users, to obtain the target file;
obtaining request information of a target requestor, and performing generating operation based on the request information and the first user intent to obtain the target file, wherein the target requestor is a recipient of the target file; and
obtaining user profile information of the multiple users, and updating the generated result of the first user intent based on the user profile information to obtain the target file.

18. The electronic device of claim 10, wherein the processor is further configured to perform one or more of:
when the target file is an image file, displaying identification information of a target image object on an image, the identification information including identification information of a target user; and
when user information of the multiple users changes, updating output parameters of the target file.

19. A non-transitory computer-readable storage medium storing computer program instructions executable by at least one processor to perform:
in response to obtaining multiple data entries from multiple users, identifying a first user intent represented by the multiple data entries;
performing generation processing based on the first user intent to obtain a target file, wherein the target file corresponds to a user intent represented by at least one of the multiple data entries.

20. The non-transitory computer-readable storage medium of claim 19, wherein identifying the first user intent represented by the multiple data entries includes one or more of:
obtaining multiple second user intents respectively represented by the multiple data entries, performing processing on the multiple second user intents represented by the multiple data entries to obtain the first user intent, wherein the first user intent includes at least one of the multiple second user intents, or the first user intent corresponds to at least one of the multiple second user intents;
performing targeted processing on the multiple data entries to obtain first data entry, and identifying the first user intent represented by the first data entry, wherein the first data entry includes at least one of the multiple data entries, or a semantic content of the first data entry corresponds to a semantic content of at least one of the multiple data entries; and
obtaining target reference information, and identifying the first user intent represented by the multiple data entries using a processing strategy based on the target reference information.
